(19) United States
(12) Patent Application Publication
(10) Pub. No.: US 2007/0132664 A1
(43) Pub. Date: Jun. 14, 2007

(54) Surface-mounted contour-fitting electronic visual display system for use on vehicles and other objects

(76) Inventor: Stuart Weissman, Armonk, NY (US)

Correspondence Address: GREENBERG TRAURIG, P.A., 1221 Brickell Avenue, Miami, FL, 33131, US

(21) Appl. No.: 11/635,242

(22) Filed: Dec. 7, 2006

Related U.S. Application Data
(60) Provisional application No. 60/748,754, filed on Dec. 8, 2005.

(51) Int. Cl. G09G 3/00

(52) U.S. Cl. 345/30

(57) ABSTRACT

A surface-mounted contour-fitting electronic visual display system for use on vehicles and other objects, comprising one or more flexible contour-fitting light-emitting elements that can be arranged and configured to be mountable on surfaces of vehicles and other objects, a system controller which connects to said one or more light-emitting elements by electronic wiring, cables or other suitable means, and a power source connected to said controller to power the system and said one or more light-emitting elements. The system can be used on various types of vehicles such as automobiles, buses, airplanes, trains and motorcycles, for purposes such as aesthetics, signaling or displaying instructional or informational messages and advertising. The system is also useful in military applications including camouflaging and other forms of visual disguise.

### BACKGROUND OF THE INVENTION

A. Technical Field

The present invention relates to methods and systems for displaying visual images on vehicles and other objects. More particularly, the present invention relates to a surface-mounted contour-fitting electronic visual display system for use on vehicles and other objects.

B. Background

Outdoor visual displays for advertisements and other messages take many forms, such as, for example, billboards, bus stop benches and housings, and conventional static signage mounted on posts, vehicles or worn by people. Advances have included improvements in mounting methods and ease of installation, including, for example, the use of electrostatic working film or shrink wrap plastic media to entirely wrap buses with advertising graphics. Still other advances have included dynamic moving visual image displays, used for more effective and aesthetically pleasing advertising as well as dissemination of important public safety information such as traffic information, amber alerts and other law enforcement notifications, such as those displayed on billboards or vehicles. Such systems generally comprise one or more rigid display panels that are mounted to substantially flat surfaces of vehicles or other objects, and are not configurable to cover the entire vehicle or object surface or conform to the contours of curved or uneven surfaces.

Moving visual image displays can take many forms, such as, for example, picture-tubes as used in televisions, plasma screens, liquid crystal display panels, light emitting diodes and other known technologies. For example, systems such as that described in U.S. Pat. No. 4,574,269, which comprises a visual communicator for a rear window of a vehicle including a message display unit with a plurality of light emitting diodes comprising a matrix arrangement and disposed in a limited discrete portion of the vehicle's rear window. The light emitting diodes are selectively energizable to emit light in the form of a message. The system includes a programmable message control unit operationally interconnected to the light emitting diodes to selectively energize them. The device is useful for buses, for example, to provide messages to following drivers notifying them of traffic conditions ahead, to request assistance or advise regarding up-coming vehicle stops. Similar systems for use on cars are disclosed in U.S. Pat. Nos. 5,905,434 and 4,868,542. Such devices obstruct part of the rear window view and are not visible from other sides of the vehicle.

The present invention advances the art by providing a visual display system that can display moving visual images on substantially the entire outer visible surfaces of vehicles and other objects with the light-emitting elements conforming to the contours of the surface on which they are mounted. The present invention is a system for the display of non-projected moving or stationary images from two and/or three dimensional objects useful for applications embodying various vehicles, including, without limitation, automobiles, trucks, buses, boats, barges, ships, aircraft, helicopters, military hardware such as personnel carriers, humvees, jeeps and tanks, and military camouflaging as well as applications on various media in the field of marketing and advertising.

### BRIEF DESCRIPTION OF THE DRAWINGS

All of the referenced drawings form part of this specification and depict preferred embodiments of the invention, but it is to be understood that the invention is not limited to the embodiments depicted therein.

FIG. 1 depicts a rendering of one embodiment of the present invention showing an automobile with its surface covered by the contour-fitting surface-mounted elements.

FIG. 2 depicts a box diagram representing the system components and their interconnection.

FIG. 3 depicts a rendering of one embodiment of the present invention in the form of an automobile describing system features and elements.

### SUMMARY OF THE INVENTION

The present invention comprises a surface-mounted contour-fitting electronic visual display device for use on vehicles and other objects. The system comprises: one or more flexible contour-fitting light-emitting elements that can be arranged and configured to be mountable on the curved and/or irregular surfaces of vehicles and other objects; a system controller which connects to the one or more flexible light-emitting elements by electronic wiring, cables or other suitable known means and also connects to a power source; and a power source connected to the controller to power the system and one or more light-emitting elements. The system can be used on various types of vehicles or objects, such as, without limitation, automobiles, buses, airplanes, trains and motorcycles, for purposes such as, without limitation, aesthetics, signaling or displaying instructional or informational messages and advertising.

### DETAILED DESCRIPTION OF A PREFERRED EMBODIMENT

The present invention is an electronic visual display system for use on a carrier device having a surface and one or more contours, comprising: one or more light-emitting elements configured to be mountable on said surface of said carrier and conform to said contours of said carrier surface, means for fastening said one or more light-emitting elements to said surface of said carrier, a system controller connected to said one or more light-emitting elements for processing images to be displayed via said light emitting elements, an image signal for processing by said system controller for display via said one or more light emitting elements, and a power source connected to said controller to power said system controller and said one or more light-emitting elements. The carrier device can be a vehicle or other object, and can be stationary or moving.

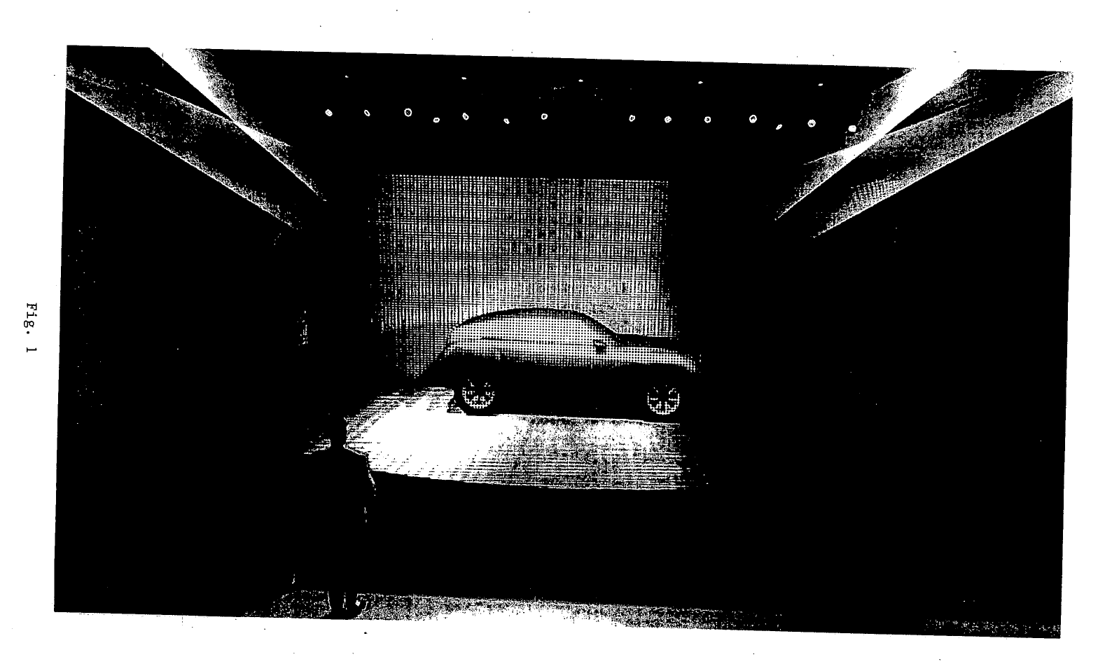

FIG. 1 depicts a rendering of an automobile embodiment of the invention. The flexible contour-fitting light-emitting elements can comprise any of various known light emitting technologies, such as, without limitation, light-emitting diodes (“LED”), liquid crystal display (“LCD”) panels or plasma panels. The light-emitting elements can be multicolored and the light emitted is preferably multicolored. The source of the emitted light is the one or more surface mounted elements as opposed to an external source such as a projector. The light-emitting elements can be contoured to cover the entire vehicle or object with the light-emitting elements oriented to generate a clearly identifiable visual image. The individual light-emitting elements are preferably attached to or otherwise installed on or embedded in the outer surface of the vehicle or object by any of various known fastening means, such as, without limitation, hook-and-loop fastening devices such as those marketed under the VELCRO® brand, wire, glue, cement, epoxy or other adhesive composition, or by attaching the light-emitting element(s) to a base fabric or other solid material, which can be a flexible sheetlike material having at least two opposite faces, with the light emitting elements attached to one face and the opposite face attached to the carrier surface, by any of the foregoing or other known means. The elements are preferably made of a flexible material but can also be molded to conform to the desired vehicle or object surface contours.

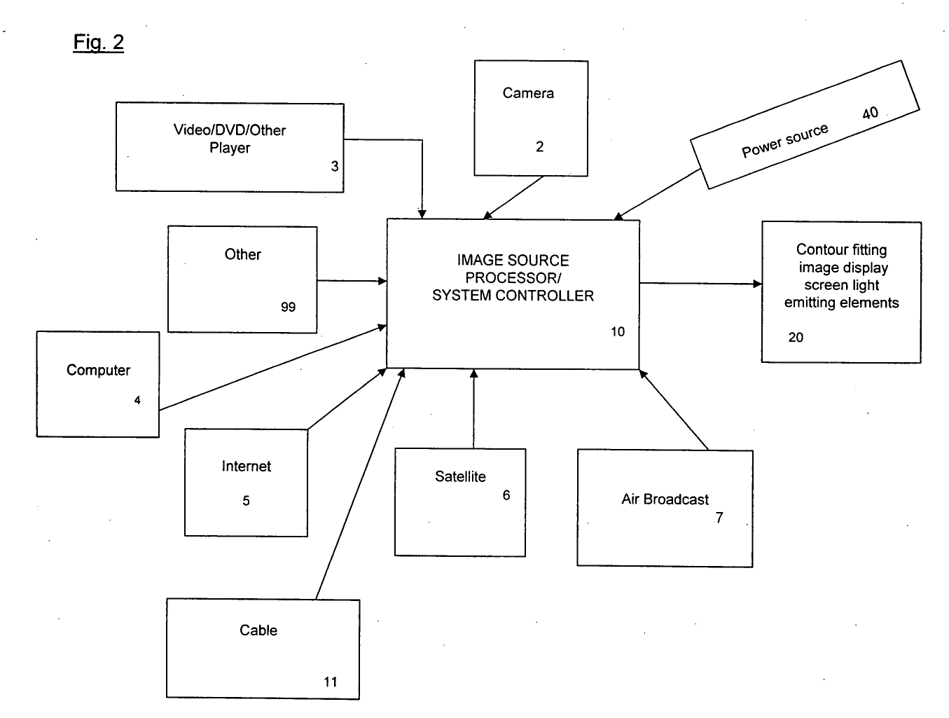

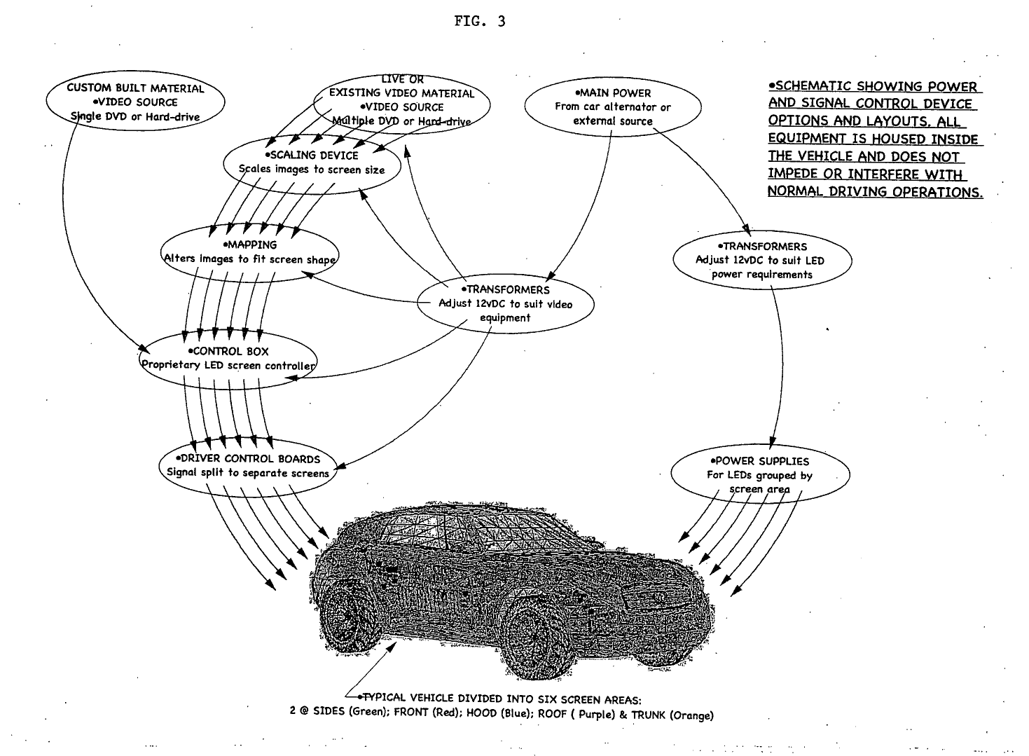

The visual images to be placed on the vehicles or objects can be digital or analog (or a combination of both) and are designed to fit the desired application and installation or display pattern. As depicted generally by the box diagram labeled FIG. 2, the images are provided from some remote source, such as, for example, a camera 2, dvd or video player 3, a computer 4, an air broadcast 7 (e.g., as with conventional television), cable 11, satellite 6, Internet 5 or other 99 transmission to the system controller 10 which processes and can store the images. Alternately, the system controller can have the images preloaded and stored within. The system controller 10 then delivers the image via suitable circuitry and processing to the light emitting elements 20 and the image is displayed on the surface of whatever vehicle or other media the elements are affixed to or otherwise installed on by the light emitting elements 20. In order to achieve two and three dimensionality, and conform to the particular surface, each light emitting element is preferably divided into individual or small groups of modules or pixels. As further described in FIG. 3, the images are preferably mapped onto the particular surface on which the light-emitting elements are installed and the image is also preferably scaled to such surface. The image is split into the various light-emitting element units or screens and together they display the desired image.

The controller 10 comprises the electronics necessary to program/load visual images to be displayed by the light-emitting elements and to control the powering and activation of the system. When the system is used on stationary objects, alternating electrical current can be utilized via a suitable power source, such as an electrical outlet with a power card connecting the system to same. Battery or other power supplies can also be used. In moving applications, the power source is preferably one or more batteries, or a generator or, in vehicles, an alternator driven by the vehicle engine. Voltage can be adjusted using transformers to the desired level. Wiring for both powering and control of the system can be internally mounted within the vehicle or object, underneath or through the surface, or external such as in a web of wires/cables designed to fit between the attached light-emitting elements.

The system can be used to display route or traffic messages on motor vehicles such as taxis and buses, or on automobiles and trucks to display images for aesthetic purposes, or to display messages such as, for example, “For Sale,” or “Prepare to Stop” or “Turning Right.” Commercial uses include displaying advertisements on vehicles such as buses, improving over prior systems such as the use of shrink wrap-plastic-based media over bus surfaces, permitting display of moving images over the entire visible outer surface of a vehicle or object.

The system is also useful in military applications including camouflaging and other forms of visual deception. In one application, the system includes one or more cameras, preferably four cameras, mounted on the opposite side of the side of a vehicle which has the light-emitting elements installed to display what is behind that particular side of the vehicle on that opposite side, rendering the vehicle visually difficult to decipher and blending the carrier vehicle with its surroundings as if camouflaged. The cameras are integrated into the vehicle's existing systems and/or electronics or alternately can operate as a stand-alone system. The system includes applications to determine the distance between the camera and the objects being shot by the camera and determine the lensing (normal, wide angle or telephoto) and send a size appropriate image to the opposite side. For example, if an enemy combatant with a rocket propelled grenade was standing 400 yards from a tree line with an open field of tall grass between him and the said tree line, the tank, with the present invention applied as camouflage, traveling in a straight line perpendicular to him would use the camera on the opposite side of the combatant to detect the distance between the tank and the individual trees, choose the appropriate lens and in real time emanate the image of the trees, in appropriate proportion, that would appear to render the vehicle invisible.

Another application of visual deception is to emanate the image of a different vehicle onto one or all of the sides. For example, if an enemy combatant heavy weaponry and electronics, was standing 400 yards away from a two lane highway through a desert, a tank, with the present invention applied as camouflage, although visible on radar, could emanate an image of a small civilian passenger car, blacking out the extra components and size bulk, giving the visual deception of a non military vehicle increasing doubt of the enemy. One could even change the color of the tank to the colors and shape of the opposition's tank.

Another possible military application is to help eliminate “friendly fire” incidents, particularly after a battle that is in its final stages. By using the system to turn the vehicle a certain color, for instance bright pink, giving aircraft and ground forces who need to visually determine if the vehicle is friend or foe an easy way to do so.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. An electronic visual display system for use on a carrier device having one or more surfaces and one or more contours, comprising:
one or more light-emitting elements configured to be mountable on said one or more surfaces of said carrier and conform to said contours of said one or more carrier surfaces,
means for fastening said one or more light-emitting elements to said one or more surfaces of said carrier,
a system controller connected to said one or more light-emitting elements for processing images to be displayed via said light emitting elements,
an image signal for processing by said system controller for display via said one or more light emitting elements, and
a power source connected to said controller to power said system controller and said one or more light-emitting elements.

2. The electronic visual display system of claim 1, wherein said one or more light-emitting elements comprises one or more light-emitting diodes.

3. The electronic visual display system of claim 1, wherein said one or more light-emitting elements comprises one or more liquid crystal display panels.

4. The electronic visual display system of claim 1, wherein said one or more light-emitting elements comprises one or more plasma panels.

5. The electronic visual display system of claim 1, wherein said one or more light emitting elements are molded to conform to said contours of said one or more carrier surfaces.

6. The electronic visual display system of claim 1, wherein said one or more light emitting elements are flexible.

7. The electronic visual display system of claim 1, wherein said fastening means comprises hook-and-loop fastening means.

8. The electronic visual display system of claim 1, wherein said fastening means comprises wire.

9. The electronic visual display system of claim 1, wherein said fastening means comprises an adhesive composition.

10. The electronic visual display system of claim 1, wherein said fastening means comprises a flexible base material having at least two opposite faces, one said face having said one or more light-emitting elements attached thereto, and said opposite face of said base material being mounted to said one or more carrier surfaces.

11. The electronic visual display system of claim 1 wherein said image signal is stored in said system controller.

12. The electronic visual display system of claim 1 wherein said image signal is transmitted to said system controller from a remote source.

13. The electronic visual display system of claim 1 wherein said one or more light emitting elements are divided into individual modules.

14. The electronic visual display system of claim 1 wherein said system controller maps said image signal onto said one or more carrier surfaces where said light emitting elements are attached and said image is scaled to said one or more surfaces.

15. The electronic visual display system of claim 1, wherein said carrier device is a stationary object.

16. The electronic visual display system of claim 1 wherein said carrier device is a moving object.

17. An electronic visual display system for use on a carrier device having one or more surfaces and one or more contours, comprising:
one or more light-emitting elements configured to be mountable on said one or more surfaces of said carrier and conform to said contours of said one or more carrier surfaces,
means for fastening said one or more light-emitting elements to said one or more surfaces of said carrier,
a system controller connected to said one or more light-emitting elements for processing images to be displayed via said light emitting elements,
an image signal for processing by said system controller for display via said one or more light emitting elements,
one or more cameras mounted on said carrier on a surface opposite to said surface where said light emitting elements are mounted, for display of what is behind said carrier on said opposite side, resulting in blending of said carrier and its surroundings, and
a power source connected to said controller to power said system controller and said one or more light-emitting elements.
